(19) United States
(12) Patent Application Publication
(10) Pub. No.: US 2013/0054315 A1
(43) Pub. Date: Feb. 28, 2013

(54) METHOD AND SYSTEM FOR PROVIDING TARGETED ADVERTISEMENTS

(71) Applicant: Jon Shutter, Chicago, IL (US)

(72) Inventor: Jon Shutter, Chicago, IL (US)

(21) Appl. No.: 13/222,158

(22) Filed: Aug. 31, 2011

(51) Int. Cl. G06Q 30/00

(52) U.S. Cl. 705/14.1

(57) ABSTRACT

A method of providing advertisements to mobile devices is disclosed. The position of a mobile device is obtained. An advertisement with a promotion for a point of interest is obtained. An incentive amount for the promotion is determined based upon the position of the mobile device. An advertisement message comprising the determined incentive amount for the promotion for the point of interest is provided to the mobile device.

### BACKGROUND OF THE INVENTION

The present invention relates to a method and system for providing advertisements, and more particularly to a method and system for providing targeted advertisements to mobile devices.

Persons who travel through a geographic region can use different types of mobile or portable computing platforms to obtain various geographically-related features and services. Mobile or portable computing platforms that provide geographically-related features and services include dedicated computing devices and general purpose computing devices. Dedicated computing devices include in-vehicle navigation systems and personal (i.e., portable or hand-held) navigation systems. General purpose computing devices include devices, such as mobile telephones, portable personal computers (e.g., notebook computers, tablets) and personal digital assistants (e.g., PDAs).

Some of the various geographically-related features and services provided by the different types of mobile or portable computing platforms include route calculation and guidance. For example, some mobile or portable computing platforms are able to provide users with an optimum route to travel by roads between locations in a geographic region. Using input from an end user, and optionally from equipment that can determine the end user's physical location (such as a GPS system), a navigation application program used by a mobile or portable computing platform system examines various paths between two locations to determine an optimum route to travel from a starting location to a destination location in the geographic region. The user of the mobile or portable computing platform is then provided with information about the optimum route in the form of instructions that identify the maneuvers required to be taken by the end user to travel from the starting location to the destination location.

Another geographically-related feature provided by some mobile or portable computing platforms is business or person finding services (e.g., electronic yellow or white pages). These services can identify addresses of individuals or businesses. These services can also identify for a user which businesses of a certain type (e.g., Chinese restaurants) are located within a given range (e.g., 3 miles) of a given location.

Although present mobile or portable computing platforms that provide geographically-related features and services are able to provide many useful advantages, there continues to be room for improvement. One area in which there is room for improvement relates to providing information to end users based upon their location. Some types of information, such as advertising, can be more effective or useful if it is restricted to only certain specific locations. For example, a gas station located in Chicago would not advertise to users located in Miami.

Accordingly, it is an objective to deliver advertising to end users who are traveling in a geographic region. One area in which there is room for improvement relates to creating and providing advertisements to the end user of the mobile or portable computing platforms. It would be beneficial to both the advertiser and the users to provide advertisements that are tailored to the end users and encourage action by the end users.

### SUMMARY OF THE INVENTION

To address these and other objectives, the present invention comprises a computer implemented method of providing advertisements to mobile devices. The method obtains a position of a first mobile device and an advertisement with a promotion for a point of interest. The method determines an incentive amount for the promotion based upon the position of the first mobile device. The method provides an advertisement message comprising the determined incentive amount for the promotion for the point of interest to the first mobile device.

According to another aspect, the present invention comprises a system for providing an advertisement. The system comprises a processor, an advertisement database stored on a computer readable medium associated with the processor, and an advertising program executed on the processor. The advertising program obtains a position of a mobile device, obtains data representing an advertisement with a promotion associated with a point of interest from the advertisement database and determines an incentive amount for the promotion for the point of interest, wherein the incentive amount is based upon the position of the mobile device.

### BRIEF DESCRIPTION OF THE DRAWINGS

An exemplary embodiment of the present invention is described herein with reference to the following drawings.

FIG. 1 illustrates an embodiment of a system for providing advertising messages in a geographic region.

FIG. 2 illustrates a more detailed view of an advertising provider of the system for providing advertising messages in a geographic region.

FIG. 3 illustrates a more detailed view of a mobile device of the system for providing advertising messages in a geographic region.

FIG. 4 is a block diagram of an advertisement database.

FIG. 5 is a flow chart for providing advertisements with targeted incentives.

FIG. 6 illustrates a map of a geographic region that depicts the location of two mobile devices and providing advertisements with targeted incentives, according to an example embodiment.

### DETAILED DESCRIPTION OF THE PRESENTLY PREFERRED EMBODIMENTS

I. Advertising System Overview

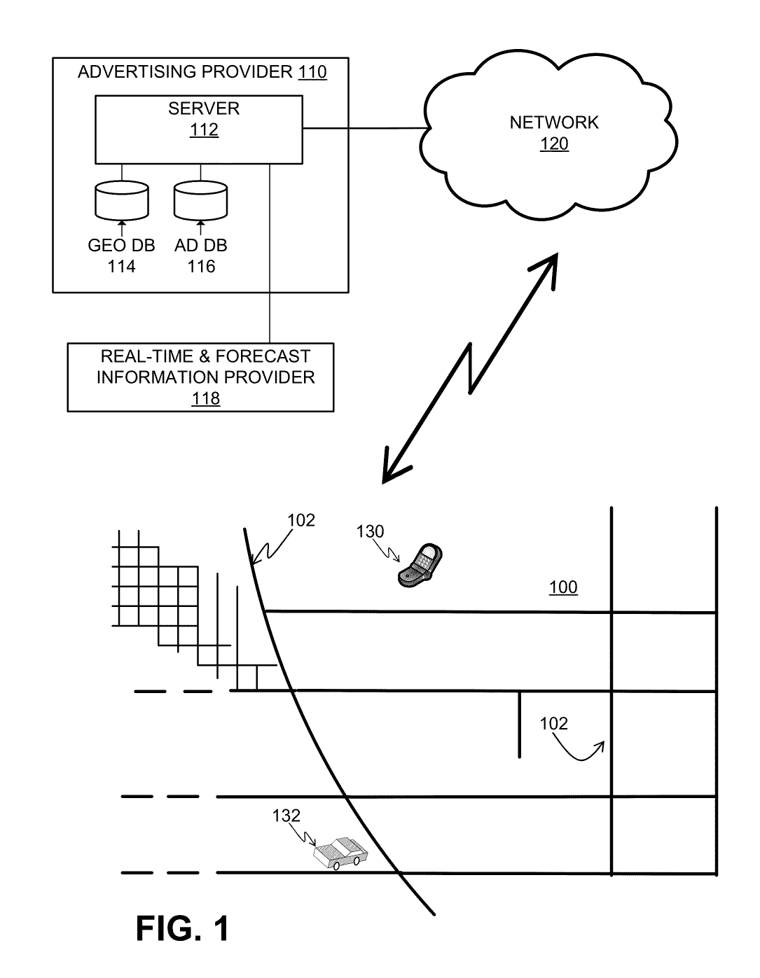

FIG. 1 is diagram illustrating a region 100. The region 100 may be a metropolitan area, such as the New York metropolitan area, the Los Angeles metropolitan area, or any other metropolitan area. Alternatively, the region 100 may be a state, province, or country, such as Illinois, France, or Germany. Alternatively, the geographic region 100 can be a combination of one or more metropolitan areas, states, countries, and so on. Located in the region 100 are a road network and a pedestrian network 102. The road network 102 provides a series of connected road segments and intersections; the pedestrian network comprises sidewalks and pedestrian paths. Furthermore, the region 100 includes a public transit network and bicycle path network.

FIG. 1 illustrates an embodiment of a system for providing advertising messages. The system includes an advertising provider 110, a network 120, and a mobile device 130. The mobile device 130 may be a cellular telephone, a mobile phone, a smart phone, a personal digital assistant (“PDA”), a tablet computer, a laptop, a personal navigation device (“PND”), a portable navigation device, a navigation system built into a vehicle and/or any other electronic device. The mobile device 130 may be associated with vehicles 132 that travel on the road network 102 in the region 100. The vehicles 132 may include a variety of cars, trucks, and motorcycles. The mobile device 130 may also be carried by a pedestrian or person traveling on public transit, bicycle or other mode of transportation.

The mobile device 130 includes suitable equipment that enables them to receive the advertising messages sent by the advertising provider 110. The advertising provider 110 transmits data indicating advertisements for points of interests, such as businesses and facilities including retail stores, restaurants, entertainment facilities, and so on, located in the region 100 or for services that are available in the region 100, sometimes referred to as advertising messages or advertisement messages. The mobile devices 130 that receive the advertising messages may include various different computing platforms.

The advertising provider 110 includes at least a server 112, a geographic database 114 and an advertisement database 116. Additionally, the advertising provider 110 receives real-time and forecast information from a real-time and forecast information provider 118. The network 120 and the communication paths between the advertising provider 110 and the network 120 may be any protocol or physical connection that is used to couple a server to a computer. The communication paths may utilize cellular, Ethernet, wireless, transmission control protocol (TCP), internet protocol (IP), or multiprotocol label switching (MPLS) technologies. In addition, the communication paths between the mobile device 130 and the network 120 may utilize cellular technologies including 3G, 4G, or WiMAX. As used herein, the phrases “in communication” and “couple” are defined to mean directly connected to or indirectly connected through one or more intermediate components. Such intermediate components may include both hardware and software based components.

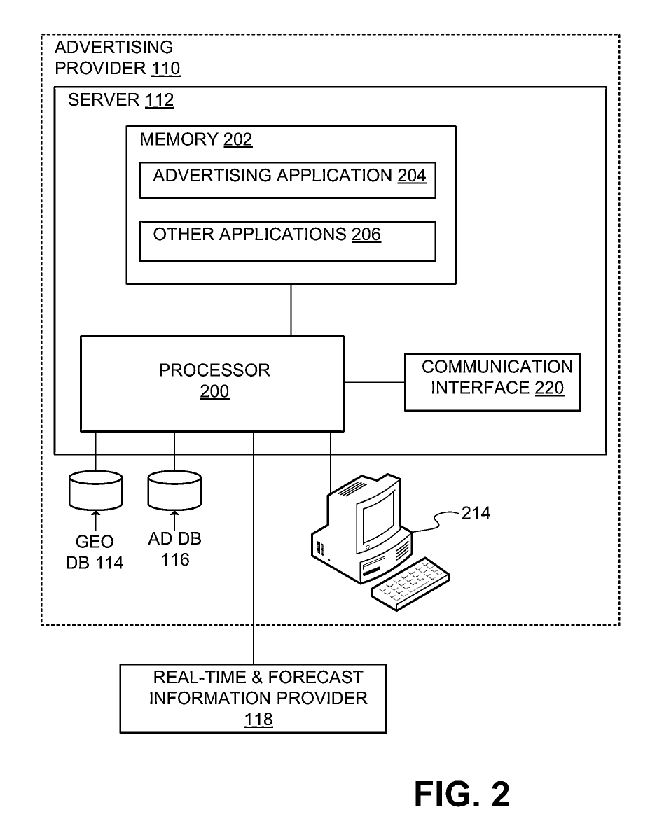

FIG. 2 illustrates a more detailed view of the advertising provider 110 of the system for providing advertising messages. The advertising provider 110 creates, formats and distributes the advertising messages to a plurality of mobile devices 130. The advertising provider 110 includes equipment and programming for creating, formatting and transmitting the advertising messages. Included among the equipment and programming of the advertising system is an advertising server 112. The advertising server 112 includes appropriate computer hardware and software to run network applications. The advertising server 112 is maintained and operated by the advertising provider 110. The advertising server 112 includes a processor 200, memory 202 and a communication interface 220. Additional, different, or fewer components may be used for the advertising server 112.

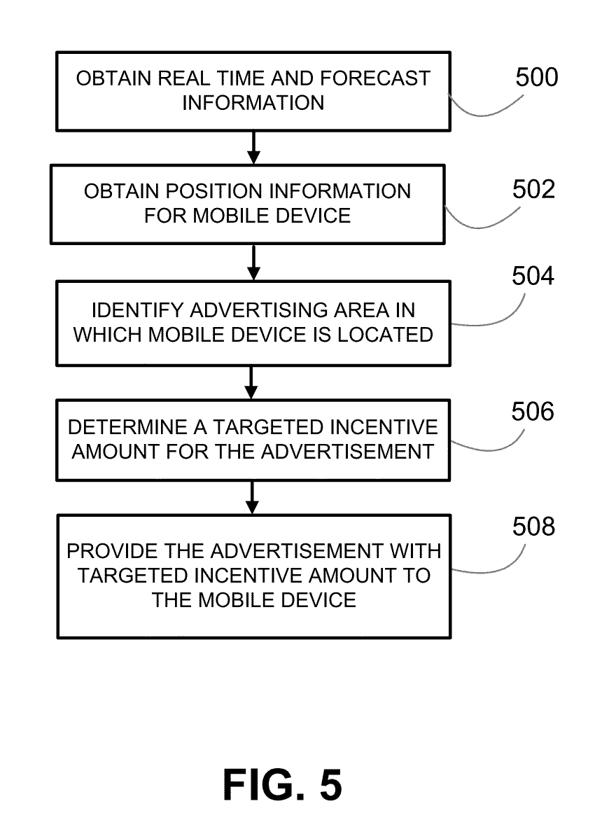

Referring to FIG. 2, server applications are included on the advertising server 112. The server applications may be stored on memory comprising one or more hard drive(s) or other computer readable media operated by the server 112 and loaded into a memory 202 of the server 112 to be executed by the processor 200. One of the server applications is an advertising application 204. The advertising application 204 creates, formats and transmits the advertising message to the mobile device 130. The operation of the advertising application will be discussed in detail in conjunction with FIG. 5 below.

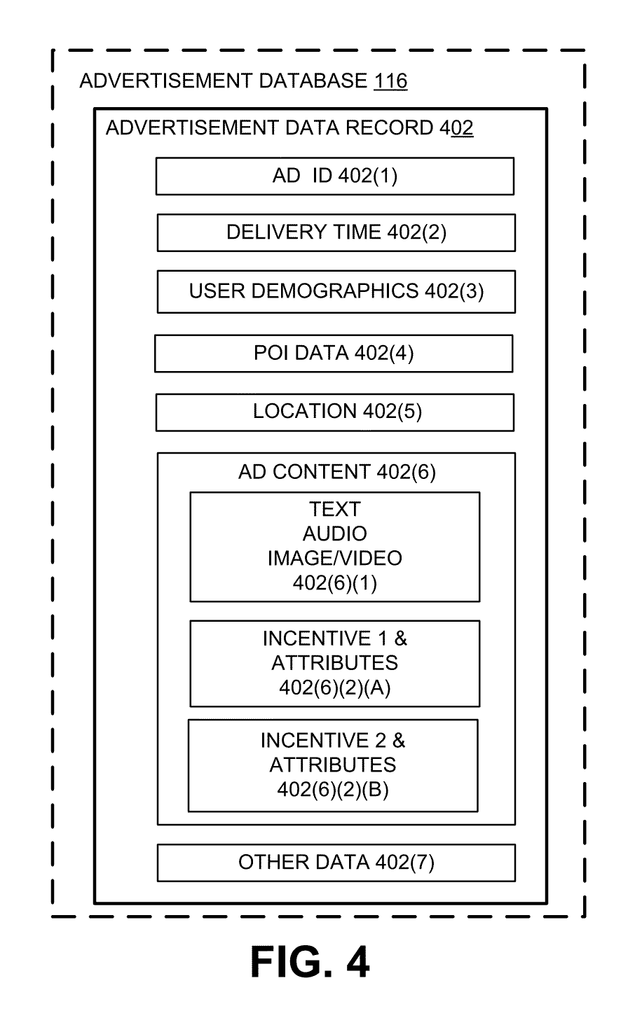

Also associated with the advertising server 112 are the geographic database 114 stored on a computer readable medium and the advertisement database 116 stored on a computer readable medium. The geographic database 114 includes geographic data representing a geographic region. The geographic data may include data representing the road network, pedestrian network, public transportation network, bicycle network and points of interest located in the geographic region. The advertisement database 116 includes data representing advertisements and data representing advertising campaigns. The advertisement database 116 is described in detail below in conjunction with FIG. 4. Moreover, the advertising server 112 receives real-time and forecast information, such as real-time and/or forecast weather information, real-time and/or up-coming event information, real-time and/or forecast traffic information, real-time and/or forecast construction information, and so on, from the real-time and forecast information provider 118. The real-time and forecast information may be stored in a computer readable storage medium associated with the server 112.

Referring to FIG. 2, other server applications 206 may be provided. One example of another server application 206 is a navigation-related server application that may include separate applications (or subprograms) that provide these various navigation features and functions. These functions and features may include route calculation (wherein a route to a destination identified by the end-user is determined), route guidance (wherein detailed directions are provided for reaching a desired destination) and other navigation-related or map-related functions and programming, such as map display, positioning (i.e., map matching), local search, destination selection and so on. The advertising application 204 and the other applications 206 may be written in a suitable computer programming language such as C, although other programming languages, such as C++ or Java, are also suitable.

Referring to FIG. 2, the advertising provider 110 also includes a workstation 214. A representative of the advertising provider 110 may use the workstation 214 to establish advertising campaigns and advertising content for the advertisements database 116. Additionally, the representative may be external to the advertising provider 110 and provide advertising campaigns and advertising content.

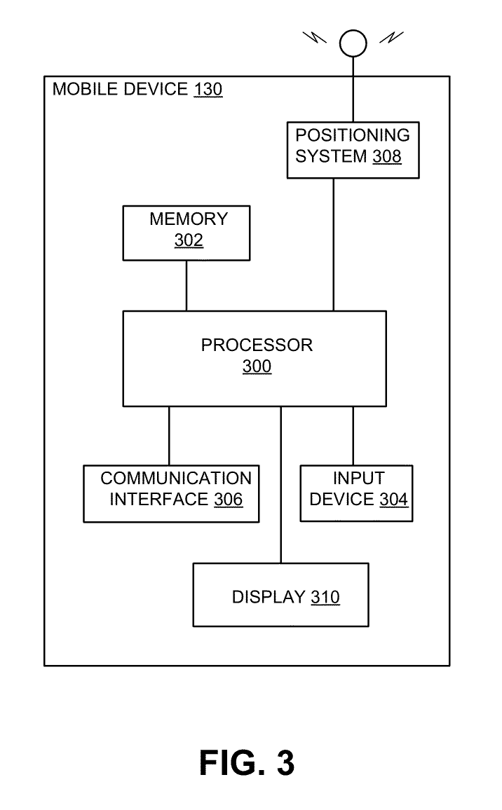

FIG. 3 illustrates a more detailed view of the mobile device 130 of the system for providing advertising messages. The mobile device 130 includes a processor 300, a memory 302, an input device 304, a communication interface 306, a positioning system 308, and a display 310. The processor 300 may be any type of processor suitable for mobile devices and/or computers.

The memory 302 may be a volatile memory or a non-volatile memory. The memory 302 may include one or more of a read only memory (ROM), random access memory (RAM), a flash memory, an electronic erasable program read only memory (EEPROM), or other type of memory. The memory 302 may include an optical, magnetic (hard drive) or any other form of data storage device. The memory 302 may be removable from the mobile device 130, such as a secure digital (SD) memory card.

The input device 304 may be one or more buttons, keypad, keyboard, mouse, stylist pen, trackball, rocker switch, touch pad, voice recognition circuit, or other device or component for inputting data to the mobile device 130. The input device 304 and the display 310 may be combined as a touch screen, which may be capacitive or resistive. The display 310 may be a liquid crystal display (LCD) panel, light emitting diode (LED) screen, thin film transistor screen, or another type of display.

The communication interface 306 may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels may be used to create an operable connection. For example, the communication interface 306 may include an output communication interface devoted to sending signals, data, packets, or datagrams and an input communication interface devoted to receiving signals, data, packets, or datagrams. The communication interface 306 provides for wireless and/or wired communications in any now known or later developed format.

The positioning system 308 includes a global positioning system (GPS), cellular, or similar position sensor for providing location data. The positioning system 308 may utilize GPS-type technology, a dead reckoning-type system, or combinations of these or other systems. The positioning system 308 may include suitable sensing devices that measure the traveling distance, speed, direction, and so on, of the device 130. The positioning system 308 may also include appropriate technology to obtain a GPS signal.

In another embodiment, the mobile device 130 may include a geographic database and navigation-related and map-related application software program(s) that provide these various navigation and map features and functions, such as route calculation, route guidance, map display, positioning, local search, destination selection and so on.

II. Geographic and Advertisement Databases

The geographic database 114 includes geographic data representing features located in a geographic region. The geographic data may include data representing the road network 102 including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the geographic data. The geographic data may also represent points of interests (POIs). The POIs may include gasoline stations, hotels, restaurants, museums, stadiums, offices, automobile dealerships, auto repair shops, buildings, stores, statues, monuments, or geographic landmarks. The data representing POIs indicate the location of the POI, including how to access the POI using the road network (or pedestrian network), and various features or attributes of the POI, including hours of operation, telephone number, types of products and services available at the POI, address, and so on. The geographic data may also represent pedestrian features including pedestrian paths, sidewalks, crosswalks, parks, plazas and so on. The geographic data may also represent public transit networks and bicycle networks. The geographic database 114 may be produced and/or maintained by a map developer, such as NAVTEQ North America, LLC located in Chicago, Ill.

In order to provide advertising messages, the advertising provider 110 uses the advertisement database 116 that includes data representing advertisements and data representing advertising campaigns. Referring to FIG. 4, the advertisement database 116 contains advertisement data records 402 that represent content and campaign information for the advertisements or advertising messages. The advertisement data 402 includes an advertisement ID 402(1) by which the advertisement data can be identified in the advertisement database 116. Each advertisement content data record 402 has associated with it information that provide information regarding the advertising campaign and the content for the advertisement message.

Referring to FIG. 4, the advertisement data 402 includes data that indicate conditions on the delivery of the advertisement and that provide guidelines and information for the advertising campaign. In one embodiment, the advertisement data 402 provides how the advertisement will be targeted to mobile devices 130. In one embodiment, the advertisement data 402 include data representing delivery time 402(2) or when the advertisement should be delivered, such as time of the day for delivery, between certain hours of the day, on certain days of the week, and so on.

The advertisement data 402 also includes data representing user demographics data 402(3) for targeted recipients for the advertisement. The user demographic data 402(3) indicates what characteristics, such as age, sex, education level, family type, income level and so on, the intended targeted users possess. For example, the demographic data may indicate that the advertisement should be targeted to females between the ages of 30 to 40 years old. Additionally, the demographics data 402(3) may include defined user preferences, defined interests and behavioral patterns.

The advertisement data 402 includes POI data 402(4) that identifies the point of interest associated with the advertisement, such as an ID of a point of interest that identifies the point of interest represented in the geographic database 114. The point of interest associated with the advertisement is typically a business, such as a retail establishment, restaurant, service establishment and so on. The POI data 402(4) provides the location of the point of interest associated with the advertisement, such as an address, latitude and longitude position, or other location reference system. The POI data 402(4) may also provide further information regarding the point of interest, such as business hours, point of interest category, telephone number, website, and other details regarding the point of interest.

The advertisement data 402 includes location data 402(5) representing locations for delivery of the advertisement or where the mobile device is located to be target with the advertisement, such as to any mobile device 130 in the geographic region, to mobile devices located in a defined portion of the geographic region, such as within a region defined by a polygon or a circle centered on a defined point location, and so on. In one embodiment, the advertisement is targeted based on the mobile devices' real time or current locations. In another embodiment, the advertisement is targeted based on the mobile devices' expected future locations or past locations. The location data 402(5) may specify a geo-fenced area or a defined area called an advertisement area, and the advertisement is to be sent to mobile devices 130 located within the geo-fenced area or advertisement area and not to the mobile devices located outside of the geo-fenced area or advertisement area.

Referring to FIG. 4, the advertisement data 402 also includes data representing content 402(6) for the advertising message. The advertisement content 402(6) comprises data representing text, audio, images and/or video 402(6)(1) and data representing multiple incentives 402(6)(2)(A) and 402(6)(2)(B) for the advertisement. The incentives, such as coupons, promotions, offers and so on, encourage the advertising recipient(s) to visit the associated point of interest or request the associated service.

The advertisement data record 402 for the single advertisement includes data representing multiple incentives 402(6)(2)(A) and 402(6)(2)(B) of different value and attributes that correspond to the different value incentive amounts. The multiple incentives of differing amounts are for the same coupons, same promotions, or same offer. For example, a first incentive value is fifty cents for a coupon for a specific product while the second incentive value is one dollar for the coupon for the same specific product. For another example, a first incentive may be a 5% discount on purchase at a sporting goods store and the second incentive may be a 10% discount on purchase at the same sporting goods store.

The attributes associated with the incentives define characteristics of the intended targeted mobile device, characteristics of the intended targeted user of the mobile device and characteristics of current conditions in the geographic region. The data representing multiple incentives 402(6)(2)(A) and 402(6)(2)(B) of different value and attributes that correspond to the different value incentive amounts allow the incentive amount of the coupon, offer or promotion to be targeted and tailored to characteristics of the mobile device, user of the mobile device and/or current conditions. Targeting incentive amounts in the advertisement allows advertisers to increase the likelihood that their advertisements would induce the desired behavior and reduce the likelihood that the advertisements are wasted without inducing the desired consumer behavior. Additionally, targeting incentive amounts in the advertisement increases the return on the advertiser's advertising investment.

In one embodiment, the attribute for the different value incentive amounts is a location-based attribute. That is, the advertisement data record 402 includes different value incentives based on the location of the mobile device. The location-based attribute for the incentive value may be a distance from the location of the mobile device to the point of interest associated with the advertisement, a travel distance from the location of the mobile device to the point of interest associated with the advertisement, a travel time from the location of the mobile device to the point of interest associated with the advertisement, and a travel cost from the location of the mobile device to the point of interest associated with the advertisement. The travel cost may consider the cost of fuel and parking or cost of public transport to travel from the location of the mobile device to the point of interest associated with the advertisement.

For example, the advertisement data record 402 provides an advertisement for a point of interest of a coffee shop that include a promotion for a cup of coffee that normal costs $1.40. The data representing a first incentive 402(6)(2)(A) provides the coffee for $1.25 with a location-base attribute comprising location of the mobile device within one mile of the coffee shop. The data representing a second incentive 402(6)(2)(B) provides the same coffee for $1.00 with a location-base attribute comprising location of the mobile device more than one mile away from the coffee shop. In one embodiment, the value of the incentive for those mobile devices located further away is larger than the value of the incentive for those located closer to the coffee shop. In this example, the larger value of the incentive is designed to encourage users to travel a greater distance to the coffee shop.

In another embodiment, the attributes for the different value incentive amounts are real-time or forecast characteristics of the geographic region including traffic, weather and event information. That is, the advertisement data record 402 includes different value incentives based on the traffic conditions, weather conditions or events occurring in the geographic region of the point of interest associated with the advertisement. For example, the advertisement data record 402 provides an advertisement for a point of interest of a coffee shop that includes a discount on beverage purchase. The data representing a first incentive 402(6)(2)(A) provides a 10% discount on beverage purchase during free flow traffic conditions or comfortable weather. The data representing a second incentive 402(6)(2)(B) provides a 25% discount on the same beverage purchase during heavy traffic conditions or rainy weather. The value of the incentive during poor traffic conditions and poor weather conditions is larger than the value of the incentive during good traffic conditions and good weather conditions. In this example, the larger value of the incentive is designed to encourage users to travel to the coffee shop during difficult traffic conditions and poor weather. For event information, the value of the incentive may be smaller during an event proximate the coffee shop, such as a concert located close to the coffee shop, whereas the incentive is larger during a time of no events. In another embodiment, the attribute may be time based, such as time of day, day of week, season and so on.

In a further embodiment, the attribute for the different value incentive amounts is a user-based attribute. That is, the advertisement data record 402 includes different value incentives based on characteristics of the user of the mobile device. The user based attribute for the incentive value may be specific user demographics, such as age, sex, education level, income level and so on. For example, the advertisement data record 402 provides an advertisement for a nightclub that includes a discount on a beverage purchase. The data representing a first incentive 402(6)(2)(A) provides a 10% discount on beverage purchase to users of mobile devices having an age less than twenty-five years. The data representing a second incentive 402(6)(2)(B) provides a 25% discount on the beverage purchase to users of mobile devices having an age greater than twenty-five years. In this example, the value of the incentive based on age is designed to encourage attendance at the nightclub by users of the mobile devices having an age greater than twenty-five years. The incentives may be tailored to users with demographics that match the typical customer of the point of interest or to encourage a diverse group of users to visit the point of interest.

In another embodiment, the user base attributes include user preferences and user history. For example, the advertisement data record 402 provides an advertisement for a bookstore that includes a discount on purchase. The data representing a first incentive 402(6)(2)(A) provides a 10% discount to users of mobile devices that favor the bookstore franchise associated with the advertisement. The data representing a second incentive 402(6)(2)(B) provides a 25% discount to users of mobile devices that prefer a competing bookstore franchise. The higher incentive is designed to encourage a visit to the bookstore by a user of the mobile device that may not typically visit the non-preferred bookstore franchise.

In another example, the advertisement data record 402 provides an advertisement for a restaurant that includes a discount on purchase and the incentive attribute is user history. The data representing a first incentive 402(6)(2)(A) provides a 10% discount to users of mobile devices that have visited the restaurant within the last six months. The data representing a second incentive 402(6)(2)(B) provides a 50% discount to users of mobile devices that have never visited the restaurant. The higher incentive is designed to encourage the user to try the restaurant.

In one embodiment, the data that represent the incentive and corresponding attributes 402(6)(2) provides an equation that considers multiple attributes and may include weights to compute a incentive value.

The advertisement data 402 includes other data 402(7). Other data 402(7) may indicate key words that would trigger the advertising message, such as a user requesting a restaurant. Additionally, the other data 402(7) may include pricing information for the advertisement.

III. Providing Advertisements with Targeted Incentive Amounts

As discussed above in conjunction with FIG. 2, the advertising provider 110 includes the advertising program 204 that provides advertisement messages for various mobile devices 130. In one embodiment, the advertising program 204 provides advertisements to mobile devices 130 by targeting values or incentive amounts within the advertisement based on attributes of characteristics of the intended targeted mobile device, characteristics of the intended targeted user of the mobile device and characteristics of current conditions in the geographic region.

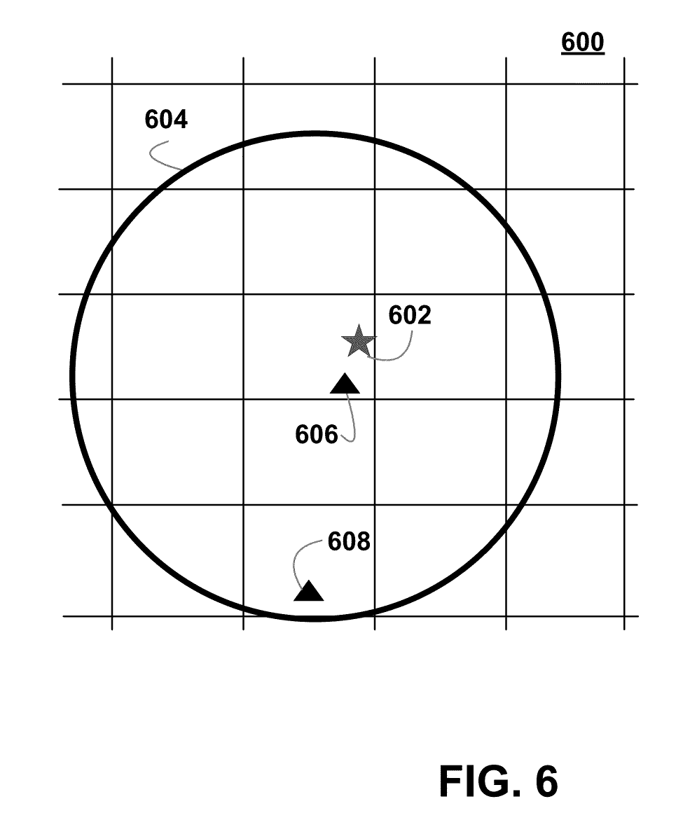

FIG. 5 illustrates a flow chart of the steps for providing a location based advertisement with a targeted incentive amount according to an example embodiment. FIG. 6 illustrates a map of a geographic region 600 that will be used to illustrate the steps discussed in conjunction with FIG. 5.

At step 500, the advertising program 204 obtains real-time and/or forecast information from the real-time and forecast information provider 118. In one embodiment, when needed by the advertising program 204, the server 112 requests specific real-time and/or forecast information for specified locations and obtains the information from the real-time and forecast information provider 118 via a communication connection. In another embodiment, the server 112 periodically obtains the real-time and/or forecast information from the real-time and forecast information provider 118 via a communication connection. For example, the server 112 obtains the current weather conditions and current traffic conditions, every five minutes. In one embodiment, the server 112 obtains the current event information for different locations and venues in the geographic region 600 at regular time intervals. For example, the current event information indicates that a stadium has a baseball game in the seventh inning with attendance of 23,000 people. In another embodiment, the server 112 obtains the information on upcoming events once or several times a day. For example, the server 112 obtains daily information regarding events for that day including location of the event, type of event, number of expected attendees, start and end time of the event and so on. In yet another embodiment, the server 112 requests specific real-time information regarding a specified venue when needed by the advertising program 204.

Referring to FIG. 5, at step 502 the advertising program 204 obtains position information for a mobile device 130. The positioning system 308 determines the location, direction, orientation and/or speed of the mobile device. In another embodiment, the server 112 may obtain the position information for the mobile device by triangulation or other cellular phone positioning method as well as by WiFi positioning. The current position may be provided to the server 112 in terms of latitude and longitude coordinates or determined by the server 112. In one embodiment, the mobile device 130 runs an application that requests an advertisement from the server 112 and includes an identification of the mobile device 130 as well as the current position information and/or demographics, interest and preference information of the user of the mobile device with the request to the server 112. Using the current position information, the advertising program 204 may identify on which road segment or pedestrian segment that the mobile device 130 is currently traveling on by map matching.

In another embodiment, the position information of the mobile device 130 is a likely future position. For example, the advertising program 204 obtains position information indicating travel plans to another city on a future date, and the destination of the travel plans is used as the position of the mobile device 130. In a further embodiment, the position may be determined by analyzing historic position data. The position data for the mobile device from many weeks may be analyzed to determine a pattern of travel and locations regularly visited. For example, by analyzing past position data, the advertising program may determine that the mobile device visits neighborhood X every Thursday from 7 pm to 10 pm.

At step 504, the advertising program 204 identifies an advertisement area in which the mobile device is located. The advertising program 204 obtains data representing the location of the advertising area 402(5) of candidate advertisements from the advertisement database 116. In one embodiment, the position information of the mobile device is compared to the size and position of the advertisement area to determine if the position of the mobile device is within the boundaries of the advertisement area. For the example shown in FIG. 6, a café 602 has an associated advertisement area 604, and a mobile device 606 and a mobile device 608 are located with the advertisement area 604. Because the mobile devices 606 and 608 are located within the advertisement area 604, the advertising program formats an advertisement for the point of interest 602 associated with the advertising area 604. In another embodiment, the advertising program 204 selects the advertisement based on advertising campaign information included in the advertisement data record such as delivery time data 402(2), and user demographics data 402(3).

At step 506, the advertising program 204 determines a targeted incentive amount for the advertisement. The advertising program 204 obtains data representing the possible incentives and corresponding attributes 402(6)(2) from the advertisement database 116. The advertising program 204 evaluates the incentive and corresponding attribute data and based on characteristics of the mobile device, user of the mobile device and/or geographic region determines the targeted incentive amount.

In one embodiment, the attribute for the different value incentive amounts is a location-based attribute that provides different value incentives based on the location of the mobile device. For example, the advertisement data record 402 provides an advertisement for the café 602 with data representing a first incentive 402(6)(2)(A) that provides the coffee for $1.25 with a location-base attribute comprising location of the mobile device within one mile of the café 602. The data representing a second incentive 402(6)(2)(B) provides the same coffee for $1.00 with a location-base attribute comprising location of the mobile device more than one mile away from the café 602. To determine the incentive value for the advertisement for the café, the advertising program 204 uses the position information of the mobile device and computes the distance between the mobile device and the location of the café 602. For example, the mobile device 606 is one quarter of a mile from the café and the mobile device 608 is two miles from the café 602. Accordingly, the advertising program 204 determines the targeted incentive amount for the mobile device 606 is $1.25 and the target incentive amount for the mobile device 608 is $1.00. For embodiments with the location-based attribute for the incentive value of a travel distance, a travel time, and a travel cost, the advertising program 204 computes a route from the position of the mobile device to the café 602 and determines the travel distance along the route, estimated travel time to travel the route and travel cost to travel the route.

In another embodiment, the attributes for the different value incentive amounts are real-time or forecast characteristics of the geographic region including traffic, weather and event information that provides different value incentives based on the characteristics of the geographic region including traffic, weather and event information. In another example, the advertisement data record 402 provides an advertisement for the café 602 with data representing a first incentive 402(6)(2)(A) that provides a 10% discount on a coffee with an attribute of sunny weather. The data representing a second incentive 402(6)(2)(B) provides a 25% discount on the same coffee with an attribute of rainy weather. To determine the incentive value for the advertisement for the café, the advertising program 204 uses the real time and/or forecast information indicating weather conditions in the region 600 obtained from the real-time and forecast information provider 118. For this example, the weather condition in region 600 is sunny skies. Accordingly, the advertising program determines the targeted incentive amount for advertisement for the mobile devices 606 and 608 is a 10% discount on a coffee. For embodiments with the attribute of traffic, events or time, the advertising program 204 obtains information representing the current traffic conditions, events or time and selects the targeted incentive amount based on the current conditions.

In a further embodiment, the attribute for the different value incentive amounts is a user-based attribute that provides different value incentives based on user demographics, such as age, sex, education level, income level and so on. In another example, the advertisement data record 402 provides an advertisement for the café 602 with data representing a first incentive 402(6)(2)(A) provides a 10% discount on a coffee to users of mobile devices having an age less than forty years. The data representing a second incentive 402(6)(2)(B) provides a 25% discount on a coffee to users of mobile devices having an age of forty years or greater. To determine the incentive value for the advertisement for the café, the advertising program 204 obtains data representing the user of the mobile device including data indicating the age of the user. The advertising program 204 may obtain the data representing the age of the user from the mobile device or from a user database. The user database may be part of the advertisement database 116 or a database stored on a different computer readable storage medium. For this example, the user of mobile device 606 is twenty-five years old, and the user of mobile device 608 is fifty years old. Accordingly, the advertising program 204 determines the targeted incentive amount for advertisement for the mobile device 606 is a 10% discount on a coffee and the targeted incentive amount for advertisement for the mobile device 608 is a 25% discount on a coffee. For embodiments with user based attributes of user preferences and user history, the advertising program 204 obtains data representing the user preferences and user history for the respective mobile devices from the user database.

Referring to FIG. 6, at step 608, the advertising program 204 provides the advertisement to the mobile device. The advertising program 204 creates the advertisement message using the advertising content data 402(6)(1) and determined targeted incentive amount. The advertisement message is transmitted to the mobile device 130 from the server 112 over the network 140. Once the mobile device 606, 608 receives the advertisement message, the advertisement message is provided to the user via the display 310 and/or other user interface of the mobile device. In one embodiment, the advertisement message is stored in memory 302 of the mobile device, and an application running on the mobile device 130 provides the advertisement to the end user of the mobile device. The end user views and interacts with the advertisement message via the display and user interface of the mobile device. For example, the end user may click to a landing page associated with the advertisement message, click to the coupon provided by the advertisement message, click to obtain a map displaying the point of interest associated with the advertisement message, click to call the point of interest associated with the advertisement message, click for directions to the point of interest associated with the advertisement message and/or click to obtain a website of the point of interest associated with the advertisement message. The messages communicating the users' response to the advertisement are provided to the mobile devices and provided to the user via the display 310 and/or other user interface of the mobile device 130. In one embodiment, the mobile device 130 may request additional information from the server 112, such as directions to the point of interest. Additionally, the server 112 may track the position of the mobile devices to determine that the devices visit the point of interest and or redeem the offer of the advertisement message. Moreover, the advertising program 204 tracks the user response to the advertisements as well as whether the incentive or coupon is redeemed. The advertising program 204 may use information from tracking the user responses to the advertisements to improve the incentive amounts offered and determined appropriate incentive amounts and attribute combinations.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

I claim:

1. A computer implemented method of providing advertisements to mobile devices, the method comprising:
obtaining a position of a first mobile device;
obtaining an advertisement with a promotion for a point of interest;
determining a targeted incentive amount for the promotion based upon the position of the first mobile device; and
providing an advertisement message comprising the targeted incentive amount for the promotion for the point of interest to the first mobile device.

2. The method of claim 1 wherein the targeted incentive amount is determined considering a distance from the position of the first mobile device to the location of the point of interest.

3. The method of claim 1 wherein the targeted incentive amount is determined considering a travel distance from the position of the first mobile device to the location of the point of interest.

4. The method of claim 1 wherein the targeted incentive amount is determined considering a travel time from the position of the first mobile device to the location of the point of interest.

5. The method of claim 1 wherein the targeted incentive amount is determined considering a travel cost from the position of the first mobile device to the location of the point of interest.

6. The method of claim 1 wherein the targeted incentive amount is determined considering traffic information for a geographic region containing the location of the point of interest.

7. The method of claim 1 wherein the targeted incentive amount is determined considering weather information for a geographic region containing the location of the point of interest.

8. The method of claim 1 wherein the targeted incentive amount is determined considering demographic information of a user of the first mobile device.

9. The method of claim 1 wherein the targeted incentive amount is determined considering preference information of a user of the first mobile device.

10. A system for providing an advertisement comprising:
a processor,
an advertisement database stored on a computer readable medium associated with the processor, and
an advertising program executed on the processor, wherein the advertising program configured to obtain a position of a mobile device, obtain data representing an advertisement with a promotion associated with a point of interest from the advertisement database and determines an incentive amount for the promotion for the point of interest, wherein the incentive amount is based upon the position of the mobile device.

11. The system of claim 10 wherein the incentive amount is determined considering a distance from the position of the mobile device to a location of the point of interest.

12. The system of claim 10 wherein the incentive amount is determined considering a travel distance or a travel time from the position of the mobile device to a location of the point of interest.

13. The system of claim 10 wherein the incentive amount is determined considering traffic conditions or weather conditions for a geographic region containing a location of the point of interest.

14. The system of claim 10 wherein the incentive amount is determined considering demographic information of a user of the mobile device.

15. The system of claim 10 wherein the incentive amount is determined considering preference information of a user of the mobile device.

16. The system of claim 10 wherein the incentive amount is determined considering user behavior information of a user of the mobile device.

17. A system for providing an advertisement comprising:
a processor,
an advertisement database stored on a computer readable medium associated with the processor, and
an advertising program executed on the processor, wherein the advertising program configured to obtain data representing an advertisement with a promotion associated with a point of interest from the advertisement database and determine an incentive amount for the promotion for the point of interest, wherein the incentive amount is based upon a location of a mobile device or characteristics of the user of the mobile device.

18. The system of claim 17 wherein the incentive amount is determined considering a distance from a location of the mobile device to a location of the point of interest.

19. The system of claim 17 wherein the incentive amount is determined considering user demographics or user preference information of a user of the mobile device.

20. The system of claim 17 wherein the incentive amount is determined considering traffic conditions or weather conditions for a geographic region containing a location of the point of interest.
